(19) United States
(12) Patent Application Publication
(10) Pub. No.: US 2003/0136327 A1
(43) Pub. Date: Jul. 24, 2003

(54) Safetyflash-a passive vehicle warning system for communicating vehicular deceleration/acceleration by embedding high contrast visual display patterns in vehicle tire treads. A strip of white, yellow, red, or other high contrast colored rubber is embedded in black tire treads by tire manufactures to provide visual cues to following vehicles regarding vehicle deceleration and acceleration in low speed regimes associated with stop and go traffic. This invention helps prevent rear end collisions and reduces vehicle collision potential for bicycles or motorcycles

(76) Inventor: James Bunnell, Cedar Creek, TX (US)

Correspondence Address: James Bunnell, 166 Colorado Drive, Cedar Creek, TX, 78612-3401, US

(21) Appl. No.: 10/051,659

(22) Filed: Jan. 22, 2002

(51) Int. Cl. B60Q 11/00

(52) U.S. Cl. 116/28 R; 340/425.5

(57) ABSTRACT

A passive warning system for communicating vehicular deceleration/acceleration by embedding high contrast visual display patterns in vehicle tire treads. A strip of white, yellow, red or other high contrast colored rubber is embedded in tire treads by tire manufactures to provide obvious visual cues to following vehicles regarding vehicle deceleration and acceleration in low speed regimes associated with stop and go traffic. This invention is an aid to preventing rear end collisions by helping to alert following vehicles to changes in vehicle speed. The same technique when applied to bicycle and motorcycle tires alerts drivers to the presence of bicycles and/or motorcycles and reduces accidental collisions.

### CROSS-REFERENCE TO RELATED APPLICATIONS

This invention does not benefit from any prior patents. Following is a brief list of existing patents that also are intended to minimize rear end collisions but by using entirely different electrical system based approaches:

| | | | |
|---|---|---|---|
| 6278364 | August 2001 | Robert; Ivan | Vehicular decel. |
| | | | warning system |
| 6020814 | February 2000 | Robert; Ivan N | Deceleration warning |
| | | | system |
| 5594416 | January 1997 | Gerhaher; Max | Deceleration warning |
| | | | system |
| 4600913 | July 1986 | Caine; Harold A. | Collision avoidance |
| | | | device |
| 4258353 | March 1981 | Carlson; Robert W. | Vehicle accel/decel |
| | | | warning sys |

### STATEMENT REGARDING FEDERALLY FUNDED APPLICATIONS

This invention has not been funded or sponsored in anyway by federal programs.

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

This invention relates to a method of improving visual cues to drivers in order to reduce rear end collisions, bicycle/automobile collisions, and motorcycle/automobile collisions.

2. Background of the Invention

Death, injuries, and property damage resulting from rear end collisions, bicyclelautomobile collisions, and motorcycle/automobile collisions are often caused by a lack of situational awareness on the part of automobile drivers. Driver inattention may result from talking on their cell phone, or they may be sleepy, or their senses might be numbed by a day of work, or they might be driving with diminished capacity because of the effects of medications or alcohol. Regardless of the reason for driver inattention, disastrous accidents are all too often the end result. Providing a passive and therefore continuous visual cue by embedding a high contrast pattern in tire treads will help to minimize this class of automobile accidents and produce significant savings in lives and property damage.

### BRIEF SUMMARY OF THE INVENTION

Safetyflash provides continuously available visual cues regarding changing vehicle speeds to following drivers without resorting to complex electrical schemes. The embedded rubber patterns are inexpensive to manufacture and last for the life of the tire. Vehicle slowing in stop and go situations is reliably and visually telegraphed to following drivers. Changing tire rotation speeds are immediately obvious to following drivers regardless of how the vehicle is being slowed. This is important because in stop and go situations drivers of vehicles equipped with conventional transmissions frequently rely on engine braking to slow their vehicle. Using the engine for braking also means that brake lights are not being illuminated. Vehicles equipped with Safetyflash high contrast rubber strips always provide visual speed cues to following traffic regardless of the method being used to effect speed changes.

### BRIEF DESCRIPTION OF THE SEVERAL VIEWS OF THE DRAWING

Not Applicable

### DETAILED DESCRIPTION OF THE INVENTION

The visual cue is accomplished by embedding a high contrast color rubber in tire treads. The actual shape and configuration of the embedded rubber strip(s) will depend on individual tread designs and must be constrained by consideration of tread integrity. The following figure depicts typical configurations for example passenger car tires:

[image]

At slow speeds associated with stop and go traffic these high contrast strips of tread rubber provide clear and recognizable visual cues regarding changes in vehicle speed. Drivers following a vehicle equipped with these visual devices are less likely to be surprised by sudden vehicle slowing. As the vehicle slows the rotating pattern of contrasting rubber provides instantaneous speed change information to following vehicles resulting in fewer rear end collisions.

I claim:

1. A passive deceleration warning system comprised of a strip (or strips) of high contrast colored rubber embedded in tire treads will provide obvious visual cues to following vehicular traffic resulting in fewer rear end collisions: This device is particularly helpful in stop and goes traffic where stop light effectiveness is sometimes minimized by people lightly riding their brakes or using engine compression to decelerate.

2. Use of high contrast colored rubber strip(s) embedded in bicycle tires will provide passive visual bicycle alerts to vehicular traffic resulting in fewer bicycle/automobile collisions. Use of this invention will reduce bicycle fatalities.

3. Use of high contrast colored rubber strip(s) embedded in motorcycle tires will provide passive visual motorcycle alerts to vehicular traffic resulting in fewer motorcycle/automobile collisions. Use of this invention will reduce motorcycle fatalities.
